(19) United States
(12) Patent Application Publication
(10) Pub. No.: US 2025/0363298 A1
(43) Pub. Date: Nov. 27, 2025

(54) GENERATION SUPPORT SYSTEM, GENERATION SUPPORT METHOD, AND GENERATION SUPPORT PROGRAM

(71) Applicant: Hitachi, Ltd., Tokyo (JP)

(72) Inventors: Kiyomi WADA, Tokyo (JP); Mineyoshi MASUDA, Tokyo (JP)

(21) Appl. No.: 19/187,018

(22) Filed: Apr. 23, 2025

(30) Foreign Application Priority Data
May 24, 2024 (JP) 2024-084612

(51) Int. Cl. G06F 40/20

(52) U.S. Cl. CPC G06F 40/20

(57) ABSTRACT

When a natural sentence that is text data of a natural language is inputted, the generation support system can access a language model that interprets the natural sentence and that probabilistically predicts an answer sentence to the natural sentence. The processor outputs a generation-source ticket of a natural sentence related to an incident, a check item group to be checked for the incident, and a first prompt that is the natural sentence requesting that an answer sentence about each check item of the check item group be generated with reference to the generation-source ticket, to the language model, causes the language model to acquire a postmortem including a result of a first trial of generation of an answer sentence about each check item in the first prompt, as a result of output of the generation-source ticket, the check item group, and the first prompt, and outputs the postmortem.

### CLAIM OF PRIORITY

The present application claims priority from Japanese patent application JP 2024-84612 filed on May 24, 2024, the content of which is hereby incorporated by reference into this application.

### TECHNICAL FIELD

The present invention relates to a generation support system, a generation support method, and a generation support program that provide support in generation of a sentence.

### BACKGROUND ART

A postmortem is a document written to record an incident, an impact of the incident, an action taken to mitigate or eliminate the impact, a root cause of the incident, and a follow-up action to avoid the recurrence of the incident.

PTL 1 discloses a technique of aggregating incident data on correlated incidents. In PTL 1, an incident service identifies an incident in an IT environment, and determines a correlation between the incident and a different incident in the IT environment. Having determined the correlation, the incident service aggregates incident data on the incident with incident data on the different incidents, and generates a summary, using the aggregated incident data.

### CITATION LIST

### Patent Literature

PTL 1: U.S. Pat. No. 11,658,863

### SUMMARY OF INVENTION

### Technical Problem

According to the technique of PTL 1, a correlation between incidents, i.e., a relationship between incidents is automatically detected, and a summary is created by aggregating data on the detected correlation. The relationship between the incidents is detected by determining a degree of matching of keywords in items making up the incident data (IP address, identification of a device failure, identification of network vulnerability, identification of service interruption, etc.).

However, in PTL 1, information necessary for postmortem generation (an incident response process, a time required for a response, investigation information) is insufficient. In addition, in PTL 1, there is a possibility that an invalid postmortem is generated by correlating an incident with an irrelevant incident.

An object of the present invention is to clearly indicate whether an answer sentence about an item to be checked in a postmortem is present or not.

### Solution to Problem

A generation support system according to one aspect of the invention disclosed in the present application is a generation support system including a processor that executes a program, and a storage device that stores the program. When a natural sentence that is text data of a natural language is inputted, the generation support system can access a language model that interprets the natural sentence and that probabilistically predicts an answer sentence to the natural sentence. The processor executes: a first requesting process of outputting a generation-source ticket of the natural sentence related to an incident, a check item group to be checked for the incident, and a first prompt that is the natural sentence requesting that an answer sentence about each check item of the check item group be generated with reference to the generation-source ticket, to the language model; a first acquiring process of causing the language model to acquire a postmortem including a result of a first trial of generation of an answer sentence about each check item in the first prompt, as a result of output of the generation-source ticket, the check item group, and the first prompt by the first requesting process; and a first output process of outputting the postmortem acquired by the first acquiring process.

### Advantageous Effects of Invention

According to a representative embodiment of the present invention, whether an answer sentence about an item to be checked in a postmortem is present can be clearly indicated. Problems, configurations, and effects that are not described above will be clarified by the following description of embodiments.

### BRIEF DESCRIPTION OF DRAWINGS

FIG. 1 is an explanatory diagram of an example of postmortem generation.

FIG. 2 is an explanatory diagram of an example of a system configuration of a postmortem generation system.

FIG. 3 is a block diagram showing an example of a hardware configuration of a computer.

FIG. 4 is an explanatory diagram of an example of an operation program executed by a ticket management apparatus.

FIG. 5 is an explanatory diagram of an example of an agent.

FIG. 6 is an explanatory diagram of an example of a ticket DB.

FIG. 7 is an explanatory diagram of an example of a check item group.

FIG. 8 is an explanatory diagram of an example of a data structure of a postmortem.

FIG. 9 is an explanatory diagram of an example of function definition information.

FIG. 10 is an explanatory diagram of an example of a related ticket search condition.

FIG. 11 is an explanatory diagram of an example of a related ticket search history.

FIG. 12 is a sequence diagram showing an example of a prompt analysis sequence.

FIG. 13 is a sequence diagram showing an example of a task memo summary generation sequence.

FIG. 14 is an explanatory diagram of an example of a task memo summary text.

FIG. 15 is a sequence diagram showing an example of a ticket summary generation sequence.

FIG. 16 is an explanatory diagram of an example of ticket summary text.

FIG. 17 is a sequence diagram showing an example of a postmortem generation sequence.

FIG. 18 is an explanatory diagram of an example of a postmortem.

FIG. 19 is an explanatory diagram of an example of a generation support screen.

### DESCRIPTION OF EMBODIMENTS

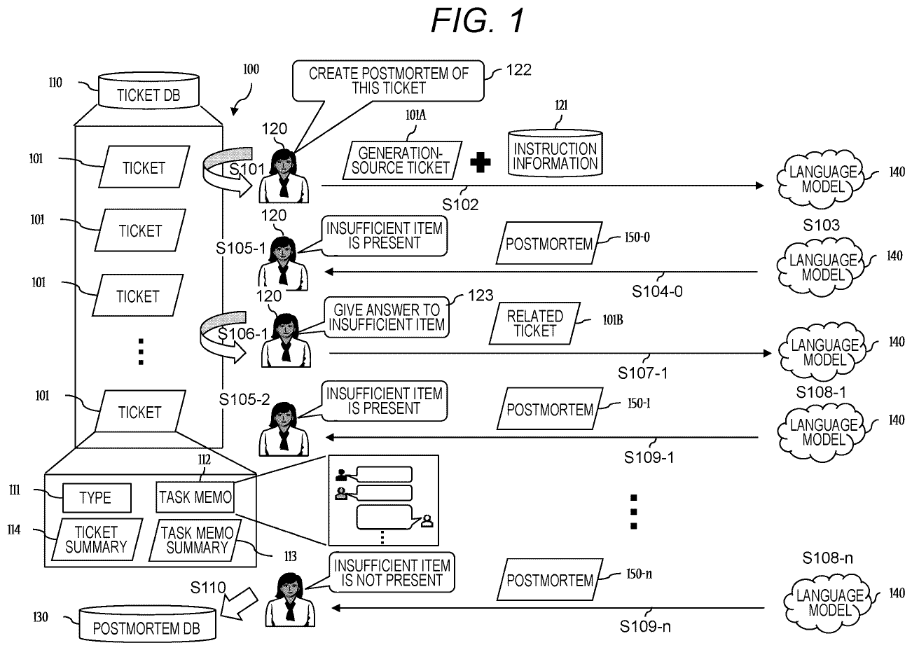

### <FIG. 1 Example of Postmortem Generation>

FIG. 1 is an explanatory diagram of an example of postmortem generation. A postmortem generation system 100 includes a ticket DB110, an agent 120, and a postmortem DB130. The ticket DB110 is a database storing tickets 101 related to incidents. A ticket 101 is text data of a natural language (natural sentence) that summarizes details of an incident. Specifically, for example, the ticket 101 includes a type 111, a task memo 112, a task memo summary 113, and a ticket summary 114.

The type 111 indicates a type of the ticket 101 (e.g., an incident, a query, a task, or a problem). In this example, the type 111 is an incident. The task memo 112 is a log of a dialogue of a natural sentence related to a task, the dialogue being made between operators about an incident. The task memo summary 113, which is data summarizing the task memo 112, includes a task memo summary text of a natural sentence summarizing the task memo 112, and a task memo summary vector created by vectorizing the task memo 112. The ticket summary 114, which is data summarizing the ticket 101, includes a ticket summary text of a natural sentence summarizing the ticket 101, and a ticket summary vector created by vectorizing the ticket 101.

The agent 120 is software that causes a processor of the postmortem generation system 100 to execute management of the ticket DB110 and the postmortem DB130 and data transmission/reception to/from a language model 140 in the postmortem generation system 100.

The language model 140 is a probability model trained by natural language processing using a data set, which is a set of text data of a natural language. The language model 140 generates a sentence according to an instruction of a prompt. The natural language processing is processing that a computer executes according to a purpose by understanding a sentence written in a natural language. Specifically, the natural language processing includes, for example, morphological analysis, syntactic parsing, semantic analysis, context analysis, and intent analysis.

The morphological analysis is an analysis by which a sentence is decomposed into morphemes, which are minimum units composing a natural language, to give the sentence parts of speech. The syntactic parsing is an analysis of the grammatical structure of a natural language, clarifying the structure and meaning of a sentence. The semantic analysis is an analysis of the semantics of a natural language, allowing understanding of the meaning of a word or a sentence to make a logical judgment or inference. The context analysis is an analysis by which a natural language is understood as contexts before and after a sentence are taken into consideration. The intention analysis is an analysis by which an intention of a speaker or a writer is extracted from a dialogue or sentence using a natural language.

The language model 140 is a type of probability model used in the natural language processing, serving as a model for probabilistically predicting how a given word or sentence is likely to come forth as a natural language. Specifically, the language model 140 is a mathematical model that in the field of natural language processing, learns language patterns and grammatical rules to generate or understand a natural language. For example, the language model 140 calculates a probability of appearance of a given word string or sentence or compares probabilities of appearance of a plurality of word strings or sentences, thereby, when predicting a word or sentence to come forth next, automatically generating a word or sentence that is most likely to come forth based on the current context.

In this manner, when receiving a query called a prompt, the language model 140 outputs an answer sentence to the query, the answer sentence being given by combining the morphological analysis, syntactic parsing, semantic analysis, context analysis, and intention analysis. The language model 140 comes in various types of language models, which include a large-scale language model like ChatGPT.

In FIG. 1, the language model 140 is disposed outside the postmortem generation system 100. The language model 140, however, may be incorporated in the postmortem generation system 100.

Hereinafter, for convenience in description, processes executed by the processor will be described with the agent 120 defined as the subject of the description. Further, for convenience in description, processes executed by the processor will be described with a program different from the agent 120 also defined as the subject of the description.

### (Step S101)

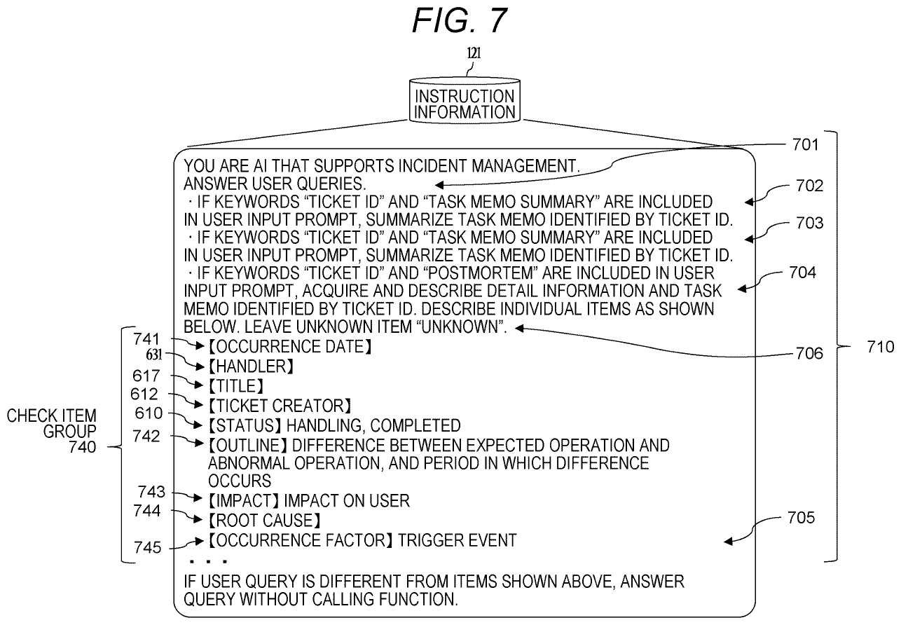

When the agent 120 receives a request for generating a postmortem 150-i (i is an integer satisfying 1≤i≤n, its initial value is i=0, and n is an integer satisfying i≤n) with respect to a certain ticket 101 (which will hereinafter be referred to as “generation-source ticket 101A”), the request being made by a user operation, the agent 120 acquires the generation-source ticket 101A from the ticket DB 110. The generation-source ticket 101A includes its task memo summary 113. Instruction information 121 is a prompt for the agent 120. The instruction information 121 includes, for example, a check item group 740 that is a set of check items necessary for the postmortem 150-i, and is text data of a natural language for making an inquiry about the check item group 740. The check item group 740 includes, for example, an incident title, an impact, a root cause, and an occurrence factor (which will be described later with reference to FIG. 7).

### (Step S102)

The agent 120 sends a prompt 122 to the language model 140, the prompt 122 having the generation-source ticket 101A and the instruction information 121. The prompt 122 at step S102 is a query composed of text data of a natural language, the query requesting that a sentence about each item of the check item group 740 in the instruction information 121 be generated with reference to the generation-source ticket 101A.

### (Step S103)

The language model 140 makes a trial of generation of an answer sentence about each check item of the check item group 740, according to the instruction of the prompt 122 at step S102. The answer sentence is text data of a natural language to give an answer about the check item. For example, when a result of trial of generation of the answer sentence is a sentence that rejects or denies an answer, such as “unknown”, “not clear”, or “impossible to answer”, or is no answer at all, the result of trial does not constitute an answer sentence. Such a check item that leads to the trial result not constituting an answer sentence, that is, a check item devoid of an answer sentence is referred to as an insufficient item.

### (Step S104)

At step S103, the language model 140 transmits a postmortem 150-0 to the agent 120, the postmortem 150-0 including a result of trial of generation of an answer sentence about a check item.

### (Step S105-1)

The agent 120 determines whether an insufficient item is present in the postmortem 150-0. If the insufficient item is not present, the agent 120 proceeds to step S110.

### (Step S106-1)

At step S105, when the insufficient item is present, the agent 120 searches the ticket DB110 for a ticket 101 related to the generation-source ticket 101A (which will hereinafter be referred to as a related ticket 101B). The ticket summary vector of the ticket summary 114 of the related ticket 101B is, for example, a vector whose distance to the ticket summary vector of the ticket summary 114 of generation-source ticket 101A is equal to or less than a given distance.

### (Step S107-1)

The agent 120 sends a prompt 123 having the related ticket 101B, to the language model 140. The prompt 123 sent at step S107 is a query that is text data of a natural language, the query requesting that a sentence about the insufficient item be generated with reference to the related ticket 101B.

### (Step S108-1)

The language model 140 makes a trial of generation of an answer sentence about the insufficient item, according to the request by the prompt 123 sent at step S107.

### <Step S109-1>

At step S108, the language model 140 transmits a postmortem 150-1 (or a result of trial of generation of an answer sentence about the insufficient item) to the agent 120, the postmortem 150-1 including the result of trial added thereto.

Following this, the agent 120 and the language model 140 repeatedly execute steps S105 to S109 (S105-1 to S109-1, S105-2 to S109-2, . . . ) until the insufficient item is no longer present.

### (Step S109-n)

When determining that the insufficient item is no longer present after executing a series of steps S105 to S109 n times, the agent 120 stores a postmortem 150-n in the postmortem DB130. The series of steps S105 to S109 may be repeatedly executed until the insufficient item is no longer present, or may be ended when the number of times of execution reaches a given number of times. It should be noted that when postmortems 150-0 to 150-n are not distinguished from each other, they are collectively referred to as postmortem 150.

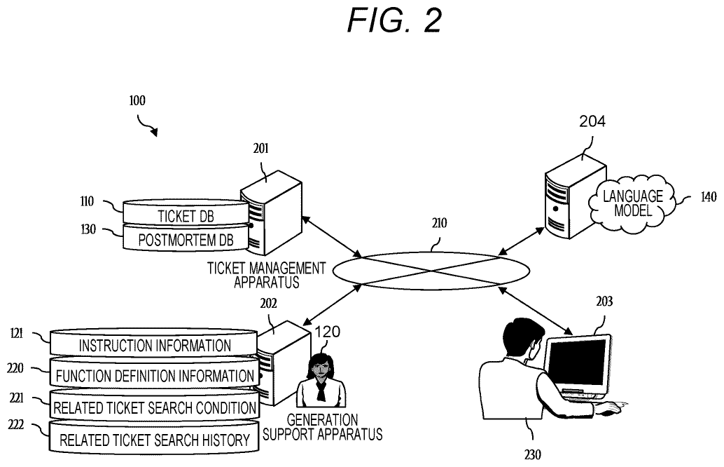

### <FIG. 2 Example of System Configuration>

FIG. 2 is an explanatory diagram of an example of a system configuration of the postmortem generation system 100. The postmortem generation system 100 includes a ticket management apparatus 201, a generation support apparatus 202, and a communication terminal 203. The ticket management apparatus 201, the generation support apparatus 202, and the communication terminal 203 are communicatively interconnected via a network 210, which is a local area network (LAN), a wide area network (WAN), or the Internet.

As shown in FIG. 1, the ticket management apparatus 201 is a computer that manages the ticket DB110 and the postmortem DB130.

The generation support apparatus 202 is a computer in which the agent 120 shown in FIG. 1 is installed. The generation support apparatus 202 is communicatively connected to an external apparatus 204 via the network 210. The generation support apparatus 202 includes instruction information 121, function definition information 220, related ticket search condition 221, and a related ticket search history 222.

The function definition information 220 is information defining a function to be executed by the postmortem generation system 100. The related ticket search condition 221 is a condition for search for the related ticket 101B. The related ticket search history 222 is a history of search for the related ticket 101B.

In FIG. 2, the ticket management apparatus 201 and the generation support apparatus 202 are depicted as different computers. However, they may be integrated into a single computer combining respective functions of the ticket management apparatus 201 and the generation support apparatus 202.

The external apparatus 204 has the language model 140. When receiving a query from the generation support apparatus 202, the external apparatus 204 generates an answer sentence, using the language model 140, and sends the answer sentence to the generation support apparatus 202.

The communication terminal 203 is a computer that allows a user 230 to make an operation input thereon and that displays output data from the ticket management apparatus 201 and the generation support apparatus 202. For example, the communication terminal 203 creates the ticket 101 according to an operation input by the user 230 and transmits the ticket 101 to the ticket management apparatus 201, which registers the incoming ticket 101 with the ticket DB 110.

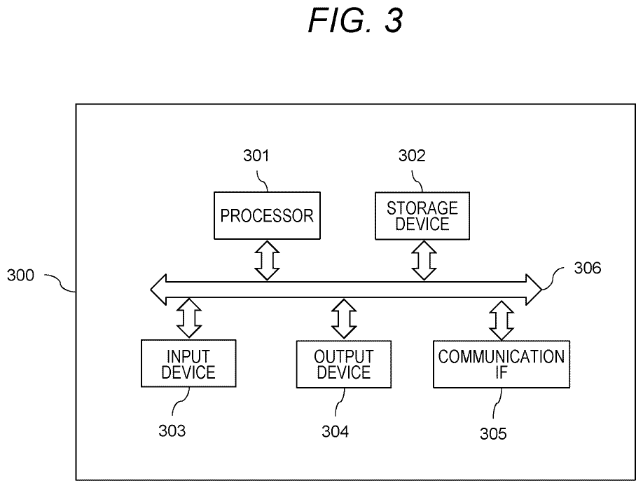

### <FIG. 3 Example of Hardware Configuration of Computer>

An example of a hardware configuration of a computer (the ticket management apparatus 201, the generation support apparatus 202, the external apparatus 204) will then be described.

FIG. 3 is a block diagram showing an example of the hardware configuration of the computer. A computer 300 includes a processor 301, a storage device 302, an input device 303, an output device 304, and a communication interface (communication IF) 305. The processor 301, the storage device 302, the input device 303, the output device 304, and the communication IF 305 are interconnected via a bus 306. The processor 301 controls the computer 300. The storage device 302 serves as a work area for the processor 301. The storage device 302 is a non-transitory or transitory recording medium that stores various programs and data. The storage device 302 includes, for example, a read only memory (ROM), a random access memory (RAM), a hard disk drive (HDD), and a flash memory. The input device 303 inputs data. The input device 303 includes, for example, a keyboard, a mouse, a touch panel, a numeric keypad, a scanner, a microphone, and a sensor. The output device 304 outputs data. The output device 304 includes, for example, a display, a printer, and a speaker. The communication IF 305, which is connected to the network, transmits and receives data.

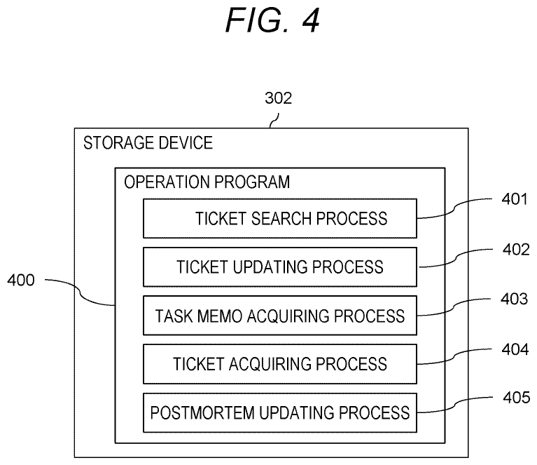

### <FIG. 4 Operation Program>

FIG. 4 is an explanatory diagram of an example of an operation program executed by the ticket management apparatus 201. The operation program 400 is stored in the storage device 302 of the ticket management apparatus 201. The operation program 400 is a program that the ticket management apparatus 201 executes according to an instruction from the generation support apparatus 202. The operation program 400 includes, as its functions, a ticket search process 401, a ticket updating process 402, a task memo acquiring process 403, a ticket acquiring process 404, and a postmortem updating process 405.

The ticket search process 401 is a function for causing the ticket management apparatus 201 to execute a process of retrieving the generation-source ticket 101A from the ticket DB 110. The ticket updating process 402 is a function for causing the ticket management apparatus 201 to execute a process of registering the ticket 101 with the ticket DB 110 or updating the ticket 101 in the ticket DB 110. The task memo acquiring process 403 is a function for causing the ticket management apparatus 201 to execute a process of acquiring the task memo 112 from the ticket DB 110. The ticket acquiring process 404 is a function for causing the ticket management apparatus 201 to execute a process of acquiring the ticket 101 from the ticket DB110. The postmortem updating process 405 is a function for causing the ticket management apparatus 201 to execute a process of registering the postmortem 150 with the postmortem DB 130 or updating the postmortem 150 in the postmortem DB 130.

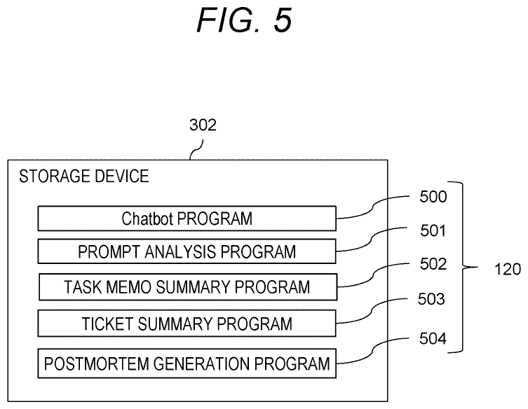

### <FIG. 5 Agent 120>

FIG. 5 is an explanatory diagram of an example of the agent 120. The storage device 302 of the generation support apparatus 202 stores a Chatbot program 500, a prompt analysis program 501, a task memo summary program 502, a ticket summary program 503, and a postmortem generation program 504, as the agent 120.

The Chatbot program 500 is a program according to which the generation support apparatus 202 automatically initiates a conversation between the user 230 and the agent 120. The Chatbot program 500 may be a rule-based type program or a machine-learning type program using the language model 140. Specifically, for example, the Chatbot program 500 outputs a conversation sentence inputted by the user 230 on the communication terminal 203, to the agent 120, or generates a replay sentence to the conversation sentence and transmits the replay sentence to the communication terminal 203.

The prompt analysis program 501 is a program according to which the generation support apparatus 202 causes the language model 140 to analyze a prompt inputted on the communication terminal 203. Specifically, for example, the prompt analysis program 501 transmits a prompt and prompt analysis information to the external apparatus 204. The prompt analysis information includes the instruction information 121 and the function definition information 220. The prompt analysis program 501 receives a prompt analysis result from the external apparatus 204.

The task memo summary program 502 is a program according to which the generation support apparatus 202 causes the language model 140 to generate the task memo summary 113. Specifically, for example, the task memo summary program 502 transmits the task memo 112 to the external apparatus 204. The external apparatus 204 generates the task memo summary 113 from the task memo 112, using the language model 140, and transmits the task memo summary 113 to the generation support apparatus 202.

The ticket summary program 503 is a program according to which the generation support apparatus 202 causes language model 140 to generate the ticket summary 114. Specifically, for example, the ticket summary program 503 transmits the ticket 101 to the external apparatus 204. The external apparatus 204 generates the ticket summary 114 from the ticket 101, using the language model 140, and transmits the ticket summary 114 to the generation support apparatus 202.

The postmortem generation program 504 is a program according to which the generation support apparatus 202 causes language model 140 to generate the postmortem 150. Specifically, for example, the postmortem generation program 504 transmits the generation-source ticket 101A and the instruction information 121, to the external apparatus 204. The external apparatus 204 generates the postmortem 150 from the generation-source ticket 101A and instruction information 121, using the language model 140, and transmits postmortem 150 to the generation support apparatus 202.

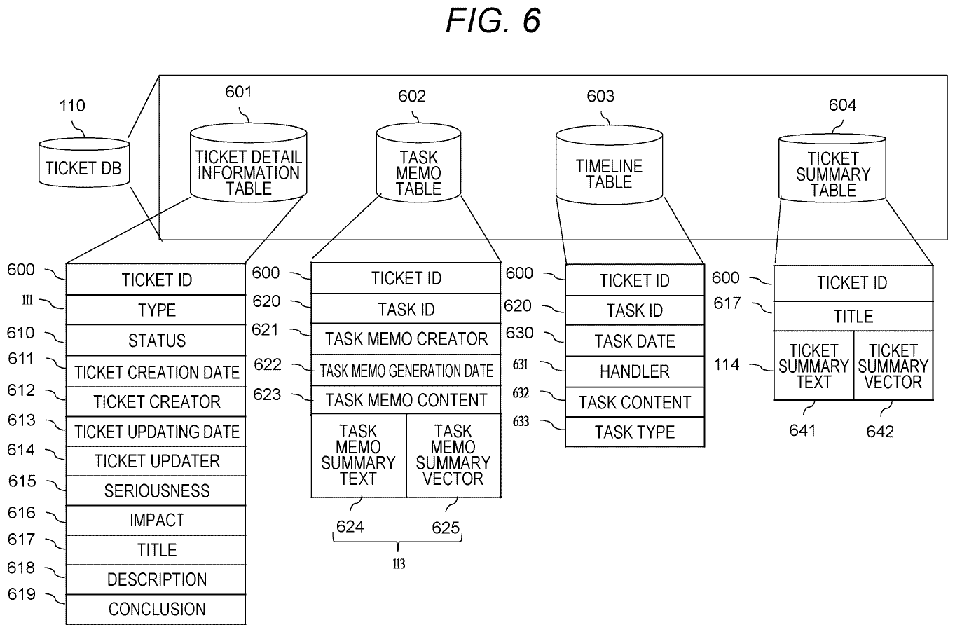

### <FIG. 6 Ticket DB110>

FIG. 6 is an explanatory diagram of an example of the ticket DB 110. The ticket DB 110 includes a ticket detail information table 601, a task memo table 602, a timeline table 603, and a summary table 604. The ticket 101 is managed by using these tables 601 to 604.

### [Ticket Detail Information Table 601]

The ticket detail information table 601 includes a ticket ID600, a type 111, a status 610, a ticket creation date 611, a ticket creator 612, a ticket updating date 613, a ticket updater 614, seriousness 615, impact 616, a title 617, a description 618, and a conclusion 619, as data structure items.

The ticket ID 600 is identification information with which the ticket 101 is uniquely identified. The status 610 represents the current status of the ticket 101 (in-process, completed, etc.). The ticket creation date 611 is a time and a day on which the ticket 101 was created, using the communication terminal 203.

The ticket creator 612 is identification information with which a user having created the ticket 101 is uniquely identified. The ticket updating date 613 is a time and a day on which the ticket 101 was updated, using the communication terminal 203, and was re-registered with the ticket DB 110. The ticket updater 614 is identification information with which a user having updated the ticket 101 is uniquely identified.

The seriousness 615 is text data of a natural language that indicates the seriousness of the type 111 (which is “incident” in this example). The impact 616 is text data of a natural language that indicates what level of impact has been exerted on what object. The title 617 is the title of the type 111 (which is “incident” in this example). The description 618 is text data of a natural language that describes the type 111 (which is “incident” in this example) in detail. The conclusion 619 is text data of a natural language that represents a final conclusion resulting from discussions on the type 111 (which is “incident” in this example).

### [Task Memo Table 602]

The task memo table 602 includes the ticket ID600, a task ID 620, a task memo creator 621, a task memo generation date 622, and a task memo content 623, as data structure items. The task ID620 is identification information with which a task on the type 111 (which is “incident” in this example) is uniquely identified. The task memo creator 621 is identification information with which the creator of the task memo 112 is uniquely identified. The task memo generation date 622 is a time and a day on which the ticket 101 was created, using the communication terminal 203. The task memo content 623 is a log of a task-related dialogue of a natural sentence, the dialog being made between operators about the type 111 (which is “incident” in this example).

The task memo summary text 624 is text data of a natural language that summarizes the task memo content 623. The task memo summary vector 625 is vector data created by vectorizing the task memo summary text 624.

### [Timeline Table 603]

The timeline table 603 includes the ticket ID 600, the task ID620, a task date 630, a handler 631, a task content 632, and a task type 633, as data structure items. The task date 630 is a time and a day on which a task identified by the task ID 620 was performed. The handler 631 is the user 230 who has handled a task identified by the task ID 620. The task content 632 is text data of a natural language that describes a task identified by the task ID 620 in detail. The task type 633 is a type of a task (e.g., “investigation”) identified by the task ID 620.

### [Ticket Summary Table 604]

The ticket summary table 604 includes the ticket ID 600, a title 617, and a ticket summary 114, as data structure items. The ticket summary 114 includes a ticket summary text 641 and a ticket summary vector 642.

The ticket summary text 641 is text data of a natural language that summarizes the ticket 101 (the status 610, the ticket creation date 611, the ticket creator 612, the ticket updating date 613, the ticket updater 614, the seriousness 615, the impact 616, the title 617, the description 618, the conclusion 619, and the task memo summary text 624). The ticket summary vector 642 is vector data created by vectorizing the ticket summary text 641.

### <FIG. 7 Instruction Information 121>

FIG. 7 is an explanatory diagram of an example of the instruction information 121. As described above, the instruction information 121 is text data of a natural language that the language model 140 can interpret. According to the instruction information 121, the language model 140 generates an answer sentence describing a function to be called. The instruction information 121 includes a first instruction sentence 701 to a fifth instruction sentence 705, and the check item group 740.

The first instruction sentence 701 is a sentence instructing the language model 140 to give an answer. The second instruction sentence 702 is a sentence instructing the language model 140 to generate the task memo summary 113. Third instruction sentence 703 is a sentence instructing the language model 140 to generate the ticket summary 114. The fourth instruction sentence 704 is a sentence instructing the language model 140 to generate the postmortem 150, that is, an answer sentence about the check item group 740. A supplementary sentence 706 is a sentence that instructs the language model 140 to give an answer “unknown” when the language model 140 does not know an answer to each check item of the check item group 740. The fifth instruction sentence 705 is a sentence that instructs the language model 140 to generate an answer not calling a function when a query from the user 230 is different in content from the second instruction sentence 702 to the fourth instruction sentence. It should be noted that the first instruction sentence 701 to the fifth instruction sentence 705 (including the supplementary sentence which are left in the instruction information 121 when the check item group 740 is removed therefrom, will be collectively referred to as an instruction sentence 710 for convenience.

The check item group 740 includes an occurrence date 741, the handler 631, the title 617, the ticket creator 612, the status 610, an outline 745, impact 746, a root cause 747, and an occurrence factor 748.

The occurrence date 741 is a time and a day on which an incident occurred. The outline 745 is an outline of the postmortem 150. The impact 746 indicates what level of impact has been exerted on what object. The root cause 747 is an underlying event having led to the occurrence of an incident. The occurrence factor 748 is a main event having caused the incident.

Referring to the generation-source ticket 101A, the language model 140 generates a sentence about the occurrence date 741, the handler 631, the title 617, the ticket creator 612, the status 610, the outline 745, the impact 746, the root cause 747, and the occurrence factor 748. According to a presence/absence check request 707 for checking the presence/absence of the task memo summary 113, the language model 140 checks whether the task memo summary 113 is present in the generation-source ticket 101A.

The content of the instruction information 121 remains valid for the language model 140 during a session lasting from transmission of the instruction information 121 to the language model 140 (step S102) to reception of the postmortem 150-n from the language model 121 (step S109-n).

Thus, after transmission of the instruction information 121 to the language model 140, for example, when a prompt “summarize a task memo with a ticket ID: 5” is transmitted to the language model 140, the language model 140 receives the prompt, and executes a process of summarizing the task memo with the ticket ID: 5, referring to the generation-source ticket 101A with the ticket ID: 5.

If the task memo is not present in the generation-source ticket 101A with the ticket ID: 5 (actually, a task memo “a slip has been issued” is present), because of the absence of the task memo (except a task memo “a slip has been issued”), the language model 140 is unable to summarize the task memo with the ticket ID: 5, thus returning an answer sentence “unable to summarize”.

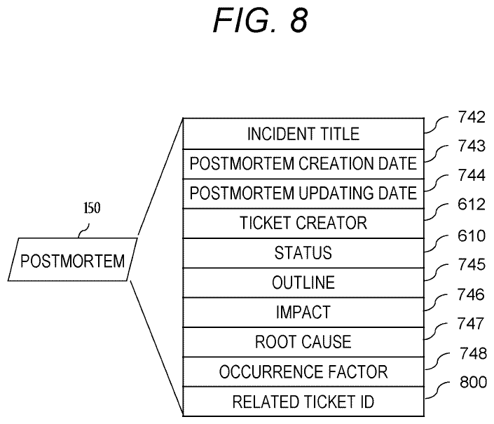

### <FIG. 8 Postmortem 150>

FIG. 8 is an explanatory diagram of an example of a data structure of the postmortem 150. The postmortem 150 includes the title 617 (incident title), a postmortem generation date 743, a postmortem updating date 744, the ticket creator 612, the status 610, the outline 745, the impact 746, the root cause 747, the occurrence factor 748, and a related ticket ID 800, as data structure items.

The related ticket ID 800 is identification information with which the related ticket 101B is uniquely identified. The related ticket ID 800 is associated with the postmortem 150-n when the postmortem 150-n is stored in the postmortem DB 130 (step S110).

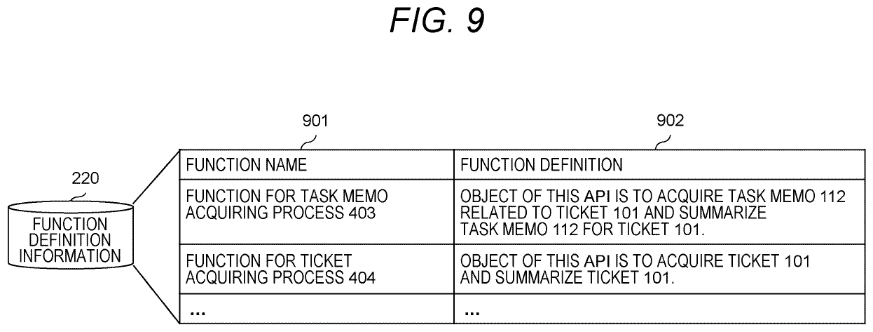

### <FIG. 9 Function Definition Information 220>

FIG. 9 is an explanatory diagram of an example of the function definition information 220. The function definition information 220 includes a function name 901 and a function definition 902. The function name 901 is the name of a function that the generation support apparatus 202 (agent 120) calls from the ticket management apparatus 201. The function definition 902 is text data of a natural language that defines a function having the function name 901. The language model 140 interprets the function definition 902, thereby specifying the task memo acquiring process 403 as a function to be called.

The function definition 902 of the ticket summary program 503 is a program for acquiring the ticket 101 from the ticket management apparatus 201 via an API and generating the ticket summary 114, using the acquired ticket 101. Therefore, for example, the language model 140 specifies the function name 901 to be called by interpreting the function definition 902.

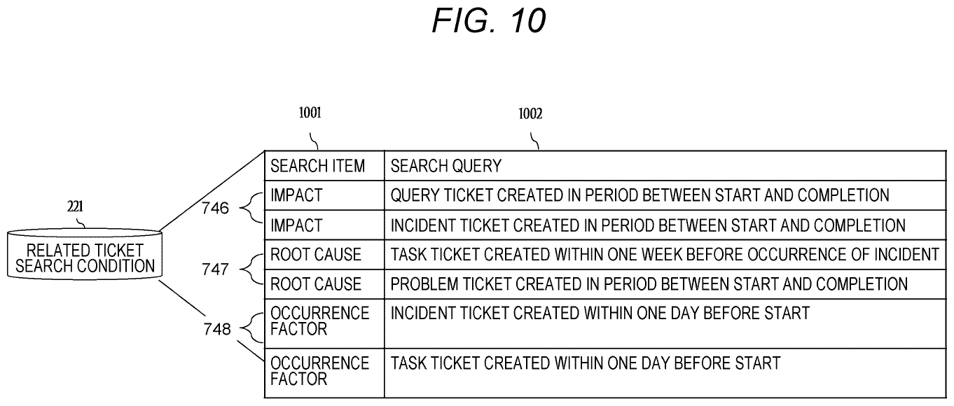

### <FIG. 10: Related Ticket Search Condition 221>

FIG. 10 is an explanatory diagram of an example of the related ticket search condition 221. The related ticket search condition 221 is a condition for searching for the related ticket 101B by the ticket search process 401. The related ticket search condition 221 includes a search item 1001 and a search query 1002. The search item 1001 is a check item for which the search query 1002 is set, the check item being among the check item group 740. The search query 1002 is a condition for specifying a search target among items in the ticket DB 110. In the search query 1002, “start” indicates opening of the ticket 101, and “completion” indicates closing of the ticket 101.

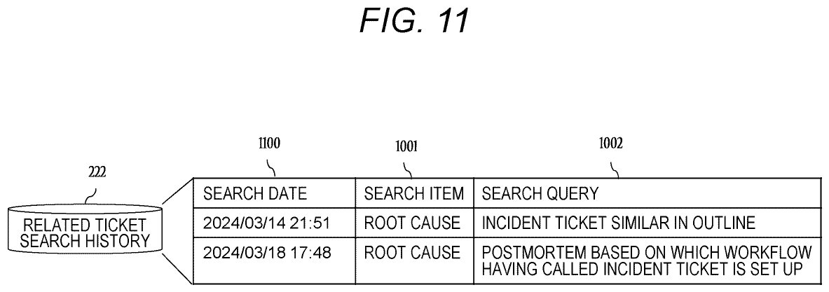

### <FIG. 11: Related Ticket Search History 222>

FIG. 11 is an explanatory diagram of an example of the related ticket search history 222. The related ticket search history 222 is the past related ticket search condition 221 used on a search date 1100 for searching for the related ticket 101B by the ticket search process 401.

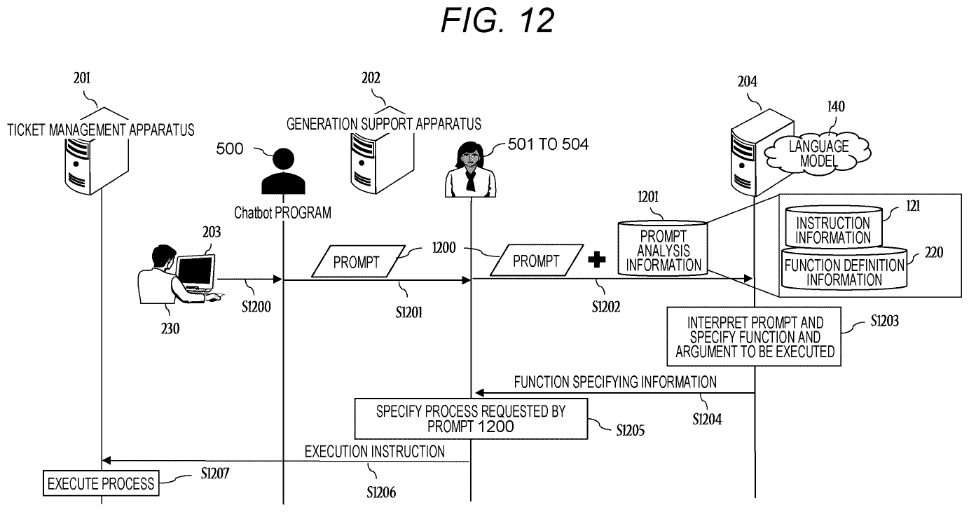

### <FIG. 12 Prompt Analysis Sequence>

FIG. 12 is a sequence diagram showing an example of a prompt analysis sequence.

### (Step S1200)

The communication terminal 203 creates a prompt 1200 by an operation input by the user 230 or by setting the ticket ID 600 on a prompt template, and transmits the prompt 1200 to the generation support apparatus 202. The prompt 1200 is text data of a natural language whose descriptive content is, for example, at least one of the instruction sentences 710 shown in FIG. 7, that is, one of a request for summarizing the task memo 112 (the second instruction sentence 702), a request for summarizing the ticket 101 (the third instruction sentence 703), and a request for generating the postmortem 150 (the fourth instruction sentence 704).

### (Step S1201)

The generation support apparatus 202, by executing the Chatbot program 500, receives the prompt 1200 from the communication terminal 203 and delivers the prompt 1200 to the prompt analysis program 501.

### (Step S1202)

The generation support apparatus 202, by executing the prompt analysis program 501, transmits the prompt 1200 and prompt analysis information 1201 to the external apparatus 204. The prompt analysis information 1201 includes the instruction information 121 and the function definition information 220.

### (Step S1203)

The external apparatus 204 inputs the prompt 1200 and the prompt analysis information 1201 to the language model 140. The language model 140 interprets the prompt 1200 and refers to the prompt analysis information 1201, thereby specifying a function and an argument that the generation support apparatus 202 should execute.

### (Step S1204)

The external apparatus 204 returns the function and argument specified at step S1203, to the prompt analysis program 501 of the generation support apparatus 202, the function and argument being returned as function specifying information.

### (Step S1205)

The generation support apparatus 202, by executing the prompt analysis program 501, refers to the function specifying information, and specifies and executes a process requested by the prompt 1200 by a program for executing the process requested by the prompt 1200. For example, when a function included in the function specifying information is the task memo acquiring process 403 only, the task memo summary program 502 instructs the ticket management apparatus 201 to execute the task memo acquiring process 403.

When a function included in the function specifying information is the ticket acquiring process 404 only, the ticket summary program 503 specifies the ticket acquiring process 404 as a process for the ticket management apparatus 201 to execute. When functions included in the function specifying information are the ticket acquiring process 404, the ticket search process 401, and the postmortem updating process 405, the postmortem generation program 504 specifies the ticket acquiring process 404, the ticket search process 401, and the postmortem updating process 405.

### (Step S1206)

The generation support apparatus 202 transmits an instruction to execute the process requested by the prompt 1200, the process being specified at step S1205, to the ticket management apparatus 201.

### (Step S1207)

The ticket management apparatus 201 executes the process in accordance with the instruction transmitted at step S1206. Specifically, for example, the ticket management apparatus 201 acquires the task memo 112, acquires the ticket 101, searches for the related ticket 101B, or registers or updates the postmortem 150.

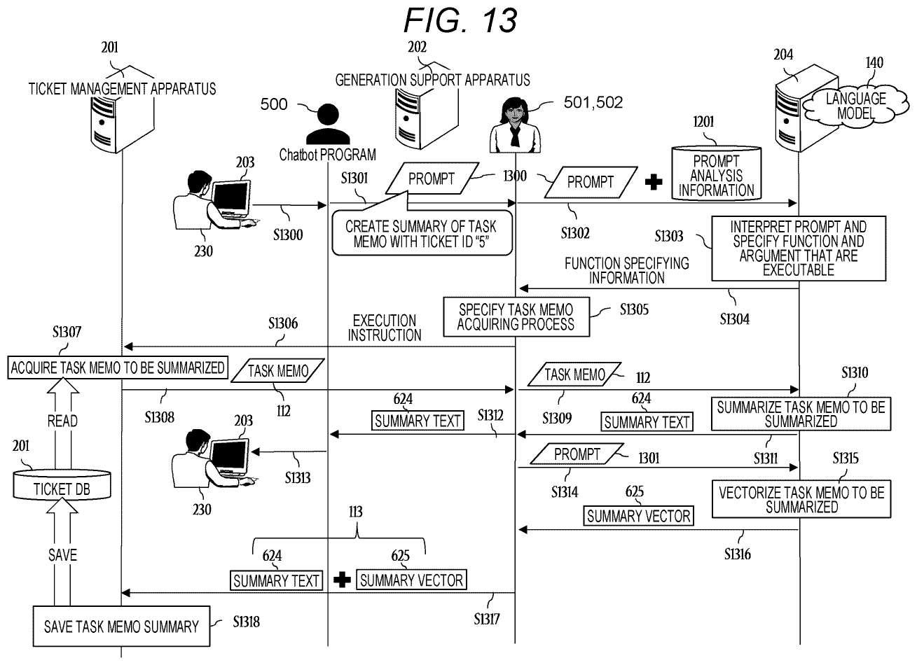

### <FIG. 13 Task Memo Summary Generation Sequence>

FIG. 13 is a sequence diagram showing an example of a task memo summary generation sequence. In FIG. 13, a series of processes executed at steps S1300 to S1307 corresponds to a series of processes executed at steps S1200 to S1207 in FIG. 12.

### (Step S1300)

The communication terminal 203 creates a prompt 1300 by an operation input by the user 230 or by setting the ticket ID 600 on a prompt template, and transmits the prompt 1300 to the generation support apparatus 202. The descriptive content of the prompt 1300 is, for example, the instruction sentences 710. The descriptive content of the prompt 1300 is considered to be applicable if it includes at least the second instruction sentence 702, that is, text data of a natural language that describes a request for summarizing the task memo 112.

### (Step S1301)

The generation support apparatus 202, by executing the Chatbot program 500, receives the prompt 1300 from the communication terminal 203 and delivers the prompt 1300 to the prompt analysis program 501.

### (Step S1302)

The generation support apparatus 202, by executing the prompt analysis program 501, transmits the prompt 1300 and the prompt analysis information 1201 to the external apparatus 204.

### (Step S1303)

The external apparatus 204 inputs the prompt 1300 and the prompt analysis information 1201 to the language model 140. The language model 140 interprets the prompt 1300 and refers to the prompt analysis information 1201, thereby specifying a function and an argument that the generation support apparatus 202 should execute. In this example, the function is the task memo acquiring process 403, and the argument is the ticket ID 600 (=5).

### (Step S1304)

The external apparatus 204 returns the function and argument specified at step S1303, to the prompt analysis program 501 of the generation support apparatus 202, the function and argument being returned as function specifying information.

### (Step S1305)

The generation support apparatus 202, by executing the prompt analysis program 501, refers to the function specifying information, and specifies a process requested by the prompt 1300. In this example, because a function included in the function specifying information is the task memo acquiring process 403 only, the task memo summary program 502 specifies the task memo acquiring process 403 as a process for the ticket management apparatus 201 to execute.

### (Step S1306)

The generation support apparatus 202, by executing the task memo summary program 502, transmits an instruction to execute the task memo acquiring process 403 on the ticket 101 with the ticket ID 600 being “5”, the task memo acquiring process 403 being the process requested by the prompt 1300 that is specified at step S1305, to the ticket management apparatus 201.

### (Step S1307)

The ticket management apparatus 201 executes the task memo acquiring process 403 on the ticket 101 with the ticket ID 600 being “5”, according to the instruction transmitted at step S1306, thus acquiring the task memo 112 to be summarized.

### (Step S1308)

The ticket management apparatus 201 returns the task memo 112 acquired at step S1307, to the generation support apparatus 202.

### (Step S1309)

The generation support apparatus 202 transmits the task memo 112 acquired from the ticket management apparatus 201, to the external apparatus 204.

### (Step S1310)

The external apparatus 204 inputs the task memo 112 having received from the generation support apparatus 202 at step S1309, to the language model 140, and generates the task memo summary text 624 in accordance with the descriptive content of the prompt 1300.

### (Step S1311)

The external apparatus 204 transmits the task memo summary text 624 generated at step S1310, to the generation support apparatus 202.

### (Step S1312)

The generation support apparatus 202, by executing the task memo summary program 502, delivers the task memo summary text 624, which has been transmitted to the generation support apparatus 202 at step S1311, to the Chatbot program 500.

### (Step S1313)

The generation support apparatus 202, by executing the Chatbot program 500, transmits the task memo summary text 624 to the communication terminal 203. Hence the task memo summary text 624 is displayed on the communication terminal 203.

### (Step S1314)

The generation support apparatus 202 transmits a prompt 1301 to the external apparatus 204, the prompt 1301 describing a request for vectorizing the task memo summary text 624. The prompt 1301 is a prompt in which the task memo summary text 624, which is to be vectorized, is embedded in a prompt template that is a description of a vectorizing request in the form of text data of a natural language.

### (Step S1315)

Receiving the request for vectorizing the task memo summary text 624, the request being transmitted at step S1314, the external apparatus 204 vectorizes the task memo summary text 624. Specifically, for example, the language model 140 executes an embedding process, which is simply called “embedding”, to express the task memo summary text 624 in terms of numerical vectors, thus converting it into the task memo summary vector 625.

### (Step S1316)

The external apparatus 204 transmits the task memo summary vector 625 generated at step S1315, to the generation

### (Step S1317)

The generation support apparatus 202 transmits the task memo summary text 624 and the task memo summary vector 625 as the task memo summary 113, to the ticket management apparatus 201.

### (Step S1318)

The ticket management apparatus 201 associates the task memo summary 113 transmitted thereto at step S1317 with the task memo 112 acquired at step S1307, and stores the task memo summary 113 in the ticket DB 201.

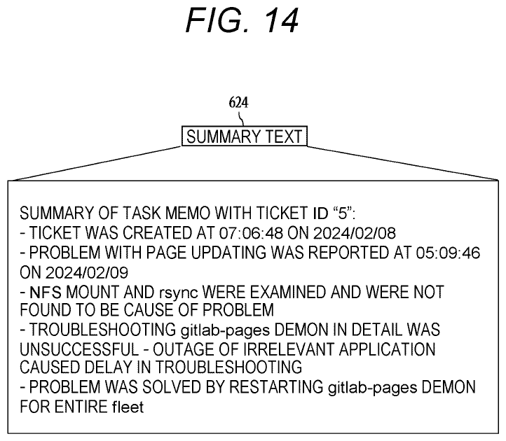

### <FIG. 14 Task Memo Summary Text 624>

FIG. 14 is an explanatory diagram of an example of the task memo summary text 624. FIG. 14 shows, as an example, the task memo summary text 624 with the ticket ID 600 being “5”.

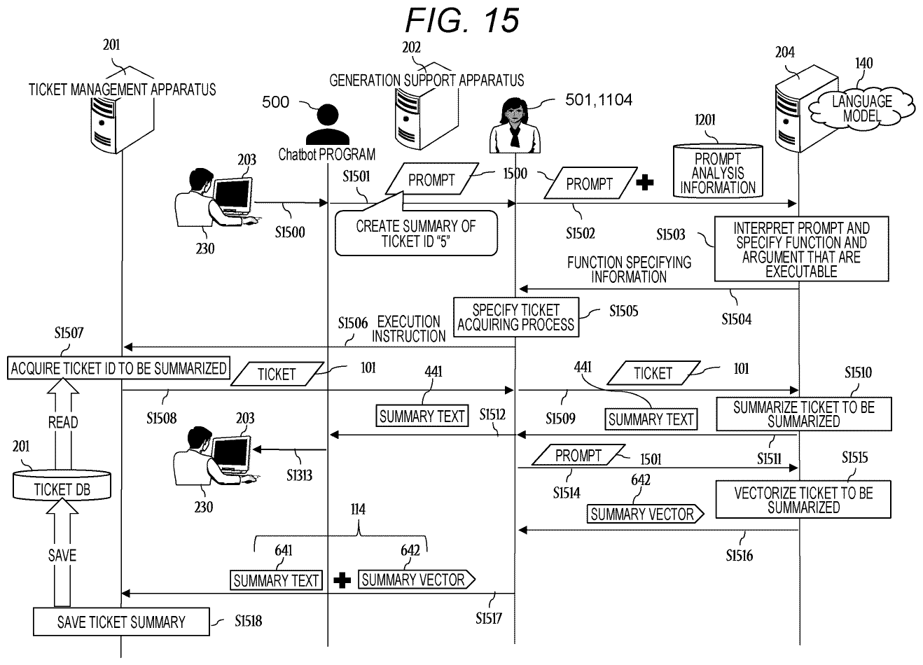

### <FIG. 15 Ticket Summary Generation Sequence>

FIG. 15 is a sequence diagram showing an example of a ticket summary generation sequence. In FIG. 15, a series of processes executed at steps S1500 to S1507 corresponds to a series of processes executed at steps S1200 to S1207 in FIG. 12.

### (Step S1500)

The communication terminal 203 creates a prompt 1500 by an operation input by the user 230 or by setting the ticket ID 600 on a prompt template, and transmits the prompt 1500 to the generation support apparatus 202. The descriptive content of the prompt 1500 is, for example, the instruction sentences 710. The descriptive content of the prompt 1500 is considered to be applicable if it includes at least the third instruction sentence 703, that is, text data of a natural language that describes s a request for summarizing the ticket 101.

### (Step S1501)

The generation support apparatus 202, by executing the Chatbot program 500, receives the prompt 1500 from the communication terminal 203 and delivers the prompt 1500 to the prompt analysis program 501.

### (Step S1502)

The generation support apparatus 202, by executing the prompt analysis program 501, transmits the prompt 1500 and the prompt analysis information 1201 to the external apparatus 204.

### (Step S1503)

The external apparatus 204 inputs the prompt 1500 and the prompt analysis information 1201 to the language model 140. The language model 140 interprets the prompt 1500 and refers to the prompt analysis information 1201, thereby specifying a function and an argument that the generation support apparatus 202 should execute. In this example, the function is the ticket acquiring process 404, and the argument is the ticket ID 600 (=5).

### (Step S1504)

The external apparatus 204 returns the function and argument specified at step S1503, to the prompt analysis program 501 of the generation support apparatus 202, the function and argument being returned as function specifying information.

### (Step S1505)

The generation support apparatus 202, by executing the prompt analysis program 501, refers to the function specifying information, and specifies a process requested by the prompt 1500. In this example, because a function included in the function specifying information is the ticket acquiring process 404 only, the ticket summary program 503 specifies the ticket acquiring process 404 as a process for the ticket management apparatus 201 to execute.

### (Step S1506)

The generation support apparatus 202, by executing the ticket summary program 503, transmits an instruction to execute the ticket acquiring process 404 on the ticket 101 with the ticket ID 600 being “5”, the ticket acquiring process 404 being the process requested by the prompt 1500 that is specified at step S1505, to the ticket management apparatus 201.

### (Step S1507)

The ticket management apparatus 201 executes the ticket acquiring process 404 on the ticket 101 with the ticket ID 600 being “5”, according to the instruction transmitted at step S1506, thus acquiring the ticket 101 to be summarized.

(Step S1508) The ticket management apparatus 201 returns the ticket 101 acquired at step S1507, to the generation support apparatus 202.

### (Step S1509)

The generation support apparatus 202 transmits the ticket 101 acquired from the ticket management apparatus 201, to the external apparatus 204.

### (Step S1510)

The external apparatus 204 inputs the ticket 101 having received from the generation support apparatus 202 at step S1509, to the language model 140, and generates the ticket summary text 641 in accordance with the descriptive content of the prompt 1500.

### (Step S1511)

The external apparatus 204 transmits the ticket summary text 641 generated at step S1510, to the generation support apparatus 202.

### (Step S1512)

The generation support apparatus 202, by executing the ticket summary program 503, delivers the ticket summary text 641, which has been transmitted to the generation support apparatus 202 at step S1511, to the Chatbot program 500.

### (Step S1513)

The generation support apparatus 202, by executing the Chatbot program 500, transmits the ticket summary text 641 to the communication terminal 203. Hence the ticket summary text 641 is displayed on the communication terminal 203.

### (Step S1514)

The generation support apparatus 202 transmits a prompt 1501 to the external apparatus 204, the prompt 1501 describing a request for vectorizing the ticket summary text 641. The prompt 1501 is a prompt in which the ticket summary text 641, which is to be vectorized, is embedded in a prompt template that is a description of a vectorizing request in the form of text data of a natural language.

### (Step S1515)

Receiving the request for vectorizing the ticket summary text 641, the request being transmitted at step S1514, the external apparatus 204 vectorizes the ticket summary text 641. Specifically, for example, the language model 140 executes an embedding process, which is simply called “embedding”, to express the ticket summary text 641 in terms of numerical vectors, thus converting it into the ticket summary vector 642.

### (Step S1516)

The external apparatus 204 transmits the ticket summary vector 642 generated at step S1515, to the generation

### (Step S1517)

The generation support apparatus 202 transmits the ticket summary text 641 and the ticket summary vector 642 as the ticket summary 114, to the ticket management apparatus 201.

### (Step S1518)

The ticket management apparatus 201 associates the ticket summary 114 transmitted thereto at step S1517 with the ticket 101 acquired at step S1507, and stores the ticket summary 114 in the ticket DB 201.

When the task memo summary text 624 is not included in the ticket 101 acquired from the ticket management apparatus 201, the generation support apparatus 202 acquires the task memo summary text 624 through the task memo summary generation sequence shown in FIG. 13, and transmits the ticket 101 including the task memo summary text 624, to the external apparatus 204 (step S159). As a result, the language model 140 can generate the ticket summary text 641 of higher quality, compared with a case where the task memo summary text 624 is not included in ticket 101.

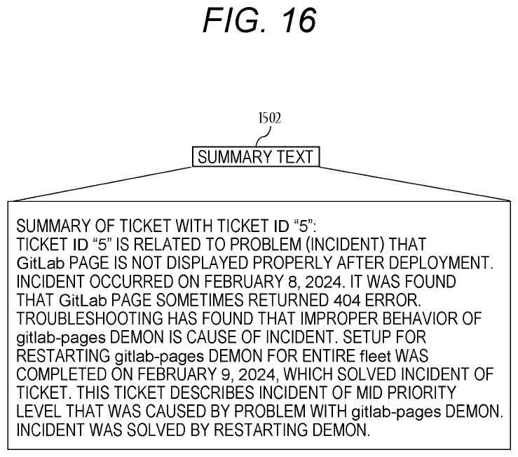

### <FIG. 16 Ticket Summary Text 641>

FIG. 16 is an explanatory diagram of an example of the ticket summary text 641. FIG. 16 shows, as an example, the ticket summary text 641 with the ticket ID 600 being “5”.

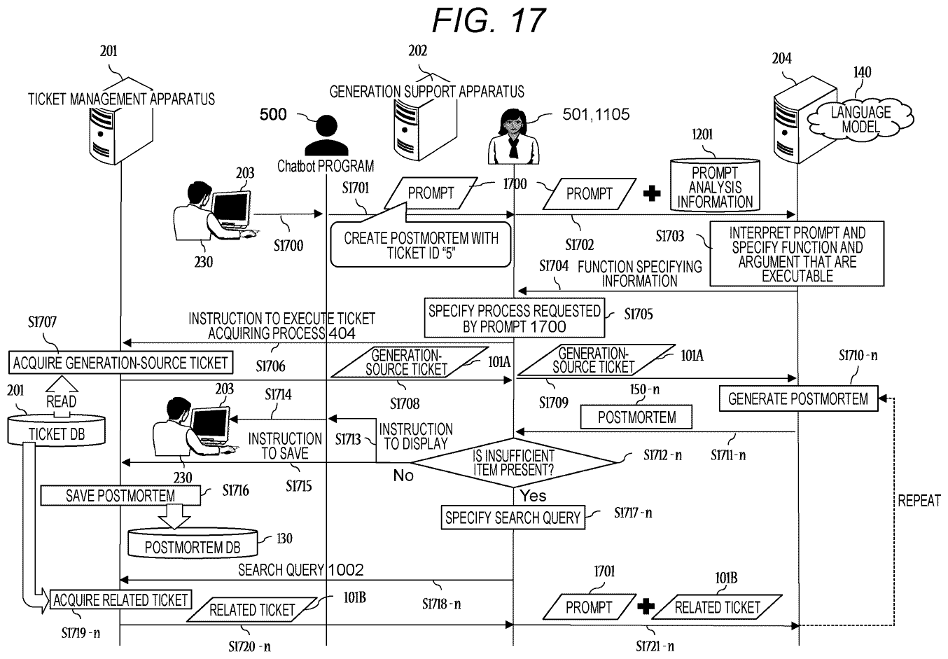

### <FIG. 17 Postmortem Generation Sequence>

FIG. 17 is a sequence diagram showing an example of a postmortem generation sequence. In FIG. 17, a series of processes executed at steps S1700 to S1707 corresponds to a series of processes executed at steps S1200 to S1207 in FIG. 12.

### (Step S1700)

The communication terminal 203 creates a prompt 1700 by an operation input by the user 230 or by setting the ticket ID 600 on a prompt template, and transmits the prompt 1700 to the generation support apparatus 202. The descriptive content of the prompt 1700 is, for example, the instruction sentences 710. It is at least the fourth instruction sentence 704, that is, text data of a natural language that describes a request for generation of a postmortem of the ticket 101.

### (Step S1701)

The generation support apparatus 202, by executing the Chatbot program 500, receives the prompt 1700 from the communication terminal 203 and delivers the prompt 1700 to the prompt analysis program 501.

### (Step S1702)

The generation support apparatus 202, by executing the prompt analysis program 501, transmits the prompt 1700 and the prompt analysis information 1201 to the external apparatus 204.

### (Step S1703)

The external apparatus 204 inputs the prompt 1700 and the prompt analysis information 1201 to the language model 140. The language model 140 interprets the prompt 1700 and refers to the prompt analysis information 1201, thereby specifying a function and an argument that the generation support apparatus 202 should execute.

In this example, for a case of generation of a postmortem 150-0, the function is the ticket acquiring process 404 and the argument is the ticket ID 600 (=5). In a case where an insufficient item is present, the function is the ticket search process 401 and the argument is the search query 1002 corresponding to the insufficient item. In a case of acquisition of the related ticket 101B, the function is the ticket acquiring process 404 and the argument is the ticket ID 600 of the ticket 101 retrieved by the search query 1002. In a case of registering or updating the postmortem 150-n, the function is the postmortem updating process 405 and the argument is the postmortem 150-n to be registered or updated.

### (Step S1704)

The external apparatus 204 returns the function and argument specified at step S1703, to the prompt analysis program 501 of the generation support apparatus 202, the function and argument being returned as function specifying information.

### (Step S1705)

The generation support apparatus 202, by executing the prompt program 501, refers to the function specifying information, and specifies a process requested by the prompt 1700. In this example, because functions included in the function specifying information are the ticket acquiring process 404, the ticket search process 401, and the postmortem updating process 405, the postmortem generation program 504 specifies the ticket acquiring process 404, the ticket search process 401, and the postmortem updating process 405.

### (Step S1706)

The generation support apparatus 202, by executing the postmortem generation program 504, transmits an instruction to execute the ticket acquiring process 404 on the ticket 101 with the ticket ID 600 being “5”, the ticket acquiring process 404 being the process requested by the prompt 1500 that is specified at step S1505, to the ticket management apparatus 201.

### (Step S1707)

The ticket management apparatus 201 executes the ticket acquiring process 404 on the ticket 101 with the ticket ID 600 being “5”, according to the instruction transmitted at step S1706, thus acquiring the generation-source ticket 101A.

### (Step S1708)

The ticket management apparatus 201 returns the generation-source ticket 101A acquired at step S1707, to the generation support apparatus 202.

### (Step S1709)

The generation support apparatus 202, by executing the postmortem generation program 504, transmits the generation-source ticket 101A acquired from the ticket management apparatus 201, to the external apparatus 204. When the generation-source ticket 101A does not include the task memo summary 113, the generation support apparatus 202 transmits also a prompt requesting generation of the task memo summary 113 of the task memo 112 in the generation-source ticket 101A, to the external apparatus 204.

(Steps S1710-n (n=0))

The external apparatus 204 inputs the generation-source ticket 101A, which is received from the generation support apparatus 202 at step S1709, and the check item group 740, to the language model 140, and generates the postmortem 150-0 according to the descriptive content of the prompt 1700. When having received the prompt requesting generation of the task memo summary 113, the external apparatus 204 generates the task memo summary 113 prior to generation of the ticket summary text 641, inputs the generation-source ticket 101A including the generated task memo summary 113, to the language model 140, and generates the postmortem 150-0.

(Step S1711-n (n=0))

The external apparatus 204 transmits the postmortem 150-n (n=0) generated at step S1710, to the generation

(Step S1712-n (n=0))

The generation support apparatus 202, by executing the postmortem generation program 504, determines whether an insufficient item is present in the postmortem 150-n (n=0) transmitted to the generation support apparatus 202 at step S1711-n (n=0). When the insufficient item is not present (step S1712-n (n=0): No), the sequence flow proceeds to steps S1713 and S1715. When the insufficient item is present (step S1712-n (n=0): Yes), the sequence flow proceeds to steps S1717-n (n=0).

### (Step S1713)

The generation support apparatus 202 delivers the postmortem 150-n and an instruction to display the postmortem 150-n, to the Chatbot program 500.

### (Step S1714)

The Chatbot program 500 transmits the postmortem 150-n to the communication terminal 203. Hence the postmortem 150-n is displayed on the communication terminal 203.

### (Step S1715)

The generation support apparatus 202 transmits an instruction to save the postmortem 150-n, to the ticket management apparatus 201.

### (Step S1716)

The ticket management apparatus 201 stores the postmortem 150-n in the postmortem DB 130.

(Step S1717-n (n=0))

The generation support apparatus 202 refers to the related ticket search condition 221, and specifies the search query 1002 for the search item 1001 matching the insufficient item. The generation support apparatus 202 may transmit the related ticket search history 222 to the communication terminal 203 through the Chatbot program 500. In this case, the related ticket search history 222 is displayed on the communication terminal 203. By the user's operation, the communication terminal 203 receives the specification of the search query 1002 from the related ticket search history 222, and transmits the search query 1002 to the postmortem generation program 504 through the Chatbot program 500. In this manner, the search query 1002 is specified.

(Step S1718-n (n=0))

The generation support apparatus 202, by executing the postmortem generation program 504, transmits the search query 1002 to the ticket management apparatus 201.

(Step S1719-n (n=0))

The ticket management apparatus 201 acquires the related ticket 101B corresponding to the search query 1002, from the ticket DB201. Specifically, for example, the ticket management apparatus 201 acquires the ticket 101 from the ticket DB 201, as the related ticket 101B, the ticket 101 corresponding to the search query 1002 and having the ticket summary vector 642 whose distance to the ticket summary vector 642 of the generation-source ticket 101A is equal to or less than a given distance.

(Steps S1720-n (n=0))

The ticket management apparatus 201 transmits the related ticket 101B to the generation support apparatus 202.

### <Step S1721>

The generation support apparatus 202 transmits the related ticket 101B and a prompt 1701 for regenerating the postmortem 150-n using the related ticket 101B, to the external apparatus 204.

(Step S1710-n (n=1))

The external apparatus 204 inputs the prompt 1701 and the related ticket 101B, which have been received from the generation support apparatus 202 at step S1721-n (n=0), to the language model 140, makes a trial of generation of an answer sentence about an insufficient item, and generates the postmortem 150-n (n=1).

(Step S1712-n (n=1))

The generation support apparatus 202, by executing the postmortem generation program 504, determines whether an insufficient item is present in the postmortem 150-n (n=1) transmitted to the generation support apparatus 202 at step S1711-n (n=1). When the insufficient item is not present (step S1712-n (n=1): No), the sequence flow proceeds to steps S1713 and S1715. When the insufficient item is present (step S1712-n (n=1): Yes), steps S1717-n (n=1)) to S1721-n (n=1)) are executed.

In this manner, steps S1710-n to S1712-n and steps S1717-n to S1721-n are repeatedly executed until the insufficient item is not present any more.

When the insufficient item is not present any more (step S1712-n: No), steps S1713 to S1716 are executed, and the postmortem generation sequence comes to an end. In this manner, in the postmortem generation sequence, the postmortem 150-n is generated until the insufficient item is not present any more, and therefore the quality of the postmortem 150-n is improved as steps S1710-n to S1712-n and steps S1717-n to S1721-n are repeated.

When the language model 140 is caused to generate the postmortem 150 using the generation-source ticket 101A without having the task memo summary text 624, the language model 140 has to generate the postmortem 150 using the ticket detail information only (the ticket ID 600, the type 111, the status 610, the ticket creation date 611, the ticket creator 612, the ticket updating date 613, the seriousness 615, the impact 616, the title 617, the description 618, the conclusion 619), in which case a process taken to reach a solution is likely to be left unknown.

When the language model 140 is caused to generate the postmortem 150-n using the generation-source ticket 101A having the task memo summary text 624, on the other hand, the language model 140 generates the postmortem 150-n including a process taken to reach a solution, the process being described in the task memo summary text 624. Thus, compared with the case where the generation-source ticket 101A does not have the task memo summary text 624, the case where the generation-source ticket 101A has the task memo summary text 624 contributes to an improvement in the quality of the postmortem 150-n.

When step S1712-n is executed a given number of times, the postmortem generation sequence may be ended even if an insufficient item is still present. For example, when a sentence about the same insufficient item is not generated a given number of times in succession, the generation support apparatus 202 may end repetitive execution of steps S1710-n to S1712-n and steps S1717-n to S1721-n.

When the number of insufficient items still present is equal to or less than a given number, the postmortem generation sequence may also be ended.

In the postmortem generation sequence, when an insufficient item is no longer present (step S1712-n: No), the postmortem 150-n is displayed on the communication terminal 203 at steps S1713 and S1714. However, when an insufficient item is still present (step S1712-n: Yes), the postmortem 150-n may be displayed on the communication terminal 203 in the same manner as at steps S1713 and S1714 in the above case.

In this case, the communication terminal 203 receives an instruction to continue the postmortem generation sequence or an instruction to end the same, the instruction being inputted by the user 230, and transmits the instruction to the postmortem generation program 504 through the Chatbot program 500. When receiving the instruction to continue the sequence, the generation support apparatus 202 specifies the search query 1002 (step S1717-n). Otherwise, the postmortem generation sequence is ended.

In the above example, at step S1710-n (n≥1), the external apparatus 204 generates the postmortem 150-n (n≥1) including a result of trial of generation of an answer sentence about an insufficient item, using the language model 140, and transmits the postmortem 150-n (n≥1) to the generation support apparatus 202. The external apparatus 204, however, may transmit not the postmortem 150-n (n≥1) but the result of trial of generation of the answer sentence about the insufficient item, to the generation support apparatus 202.

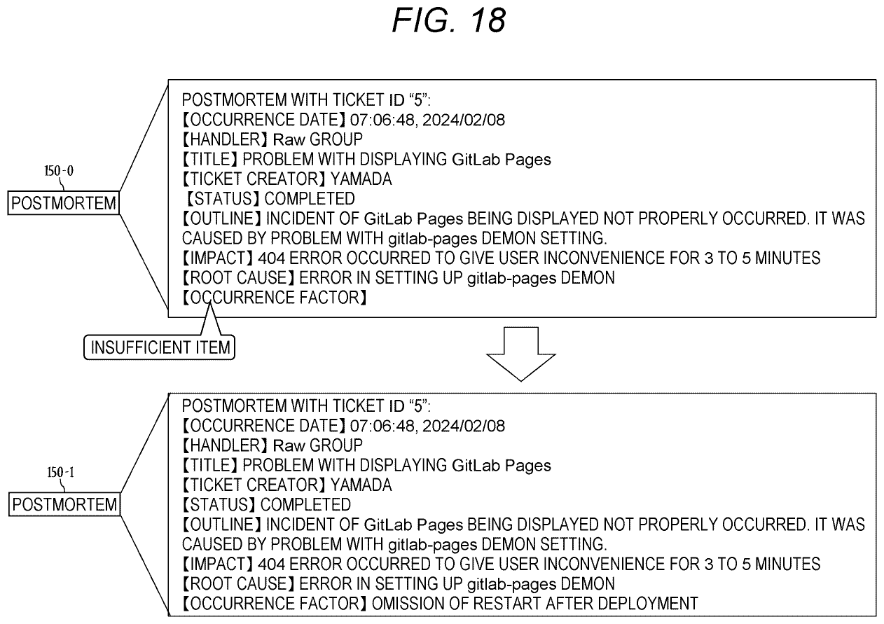

### <FIG. 18 Postmortem 150>

FIG. 18 is an explanatory diagram of an example of the postmortem 150. FIG. 18 shows, as an example, postmortems 150-0 and 150-1 with the ticket ID 600 being “5”. In the postmortem 150-0, the occurrence factor 748 is an insufficient item. To the postmortem 150-1, however, “omission of restart after deployment” is added as a sentence about the occurrence factor 748, i.e., the insufficient item, the sentence being generated by the language model 140 with reference to the related ticket 101B.

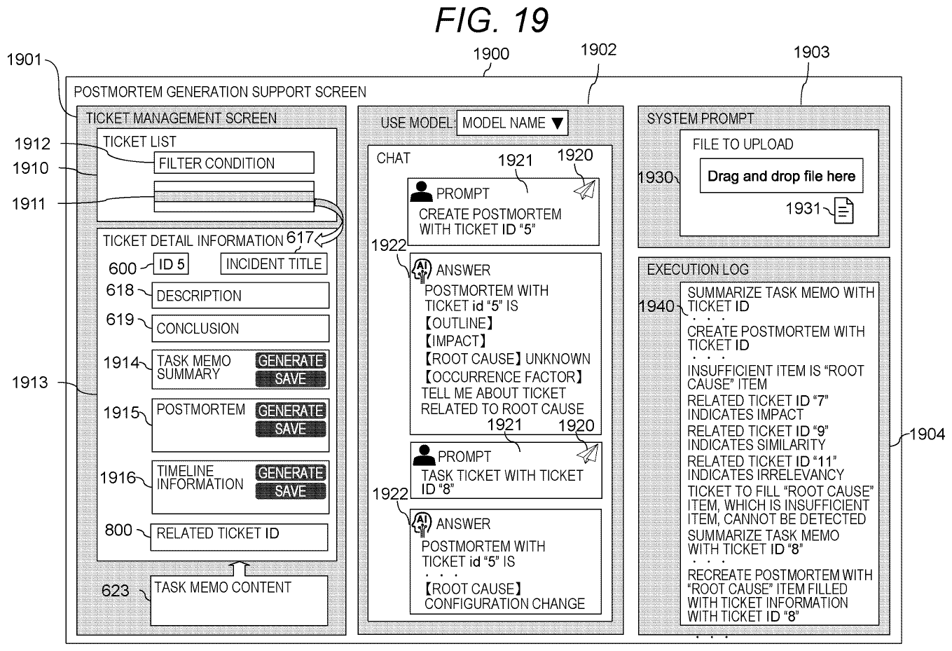

### <FIG. 19 Generation Support Screen>

FIG. 19 is an explanatory diagram of an example of a generation support screen. A generation support screen 1900 appears on, for example, a display that is an example of the output device 304 of the communication terminal 203.

The generation support screen 1900 includes a ticket management screen 1901, a chat screen 1902, a prompt analysis information setting screen 1903, and an execution log screen 1904.

### [Ticket Management Screen 1901]

The ticket management screen 1901 includes a ticket list display unit 1910. The ticket list display unit 1910 displays a list 1911 of tickets 101. The communication terminal 203 sets a filter condition 1912 according to an operation input by the user 230, and displays the list 1911 of tickets 101 of which a search range is narrowed under the filter condition 1912. The filter condition 1912 is, for example, the type 111.

The ticket management screen 1901 includes a ticket detail information display unit 1913. The ticket detail information display unit 1913 displays the ticket ID 600, the title 617 (incident title), the description 618, and the related ticket ID 800. The title 617 (incident title) is the title 617 (incident title) of the ticket 101 that is selected by the user 230 from the list 1911 of tickets 101 of which the search range is narrowed under the filter condition 1912.

The ticket detail information display unit 1913 has a task memo summary display unit 1914, a postmortem display unit 1915, and a timeline information display unit 1916. The task memo summary display unit 1914 displays the task memo summary 113.

The task memo summary display unit 1914 displays the task memo summary text 624. Pressing a generation button “generate” in the task memo summary display unit 1914 executes the task memo summary sequence shown in FIG. 13, thus displaying the task memo summary text 624 on the task memo summary display unit 1914. Pressing a saving button “save” in the task memo summary display unit 1914 (step S1317) stores the task memo summary text 624 in the ticket DB 201 (step S1318).

The postmortem display unit 1915 displays the postmortem 150. Pressing a generation button “generate” in the postmortem display unit 1915 executes the postmortem generation sequence shown in FIG. 17, thus displaying the postmortem 150 on the postmortem display unit 1915. Pressing a saving button “save” in the postmortem display unit 1915 (step S1715) stores the postmortem 150 in the postmortem DB 202 (step S1716).

The timeline information display unit 1916 displays timeline information items (the ticket ID600, the task ID 620, the task date 630, the handler 631, the task content 632, the task type 633) making up the timeline table 603. Pressing a generation button “generate” in the timeline information display unit 1916 rearranges the timeline information items (the ticket ID600, the task ID 620, the task date 630, the handler 631, the task content 632, the task type 633) in the time-series order, thus displaying the rearranged timeline information items on the timeline information display unit 1916. The communication terminal 203 can add a timeline information item specified by an operation input by the user 230. Pressing a saving button “save” in the timeline information display unit 1916 stores a timeline information item in the timeline table 603 (step S1318).

The ticket management screen 1901 displays the task memo content 623 used in the task memo summary sequence shown in FIG. 13.

### [Chat Screen 1902]

The chat screen 1902 displays a prompt 1921 (1300,1500,1700), which is an input sentence from the communication terminal 203, and an answer sentence 1922 (the task memo summary text 624, the ticket summary text 641, the postmortem 150) from the agent 120. Pressing a send button 1920 sends the prompt 1921 to the generation support apparatus 202 and then displays the answer sentence 1922 from the generation support apparatus 202. In this manner, the task memo summary text 624 and the postmortem 150 can be generated by an instruction and displayed on both the ticket management screen 1901 and the chat screen 1902.

### [Prompt Analysis Information Setting Screen 1903]

The prompt analysis information setting screen 1903 has an upload area 1930 where a prompt file 1931 can be uploaded. The prompt file 1931 carries a description of, for example, the instruction information 121 and the function definition information 220. Thus, according to an editing operation by the user 230, the communication terminal 203 edits the instruction information 121 and the function definition information 220 to change their contents, and uploads the instruction information 121 and the function definition information 220, to the generation support apparatus 202, as the prompt file 1931. In accordance with the uploaded prompt file 1931, the generation support apparatus 202 updates the instruction information 121 and the function definition information 220.

### [Execution Log Screen 1904]

The execution log screen displays data 1904 transmitted from the ticket management apparatus 201 and the generation support apparatus 202, as an execution log 1940. By checking the execution log 1940, the user 230 is able to know what the ticket management apparatus 201 and the generation support apparatus have executed and a type of a sentence the ticket management apparatus 201 and the generation support apparatus have acquired from the language model 140.

As described above, according to this embodiment, whether an insufficient item is present in the postmortem 150 can be checked. In addition, by eliminating the insufficient item, the quality of the postmortem 150 can be improved. Also, by including the task memo summary text 624 in the generation-source ticket 101A, the quality of the postmortem 150 can be improved.

The present invention is not limited to the above embodiment, and includes various modifications and configurations equivalent thereto that are within the scope of the appended claims. For example, the above embodiment has been described in detail to facilitate understanding of the present invention, and the present invention is not necessarily limited to an embodiment including all constituent elements described above. Some constituent elements of a certain embodiment may be replaced with constituent elements of another embodiment. A constituent element of another embodiment may be added to a constituent element of a certain embodiment. Some constituent elements of each embodiment may be deleted, or constituent elements of another embodiment may be added to or replaced with some constituent elements of each embodiment.

Some or all of the above constituent elements, functions, processing units, process means, and the like may be provided in the form of hardware by packaging them in an integrated circuit, or in the form of software by causing a processor to interpret and execute programs that implement respective functions.

Information for implementing the functions, such as programs, tables, and files, can be stored in a recording device, such as a memory, a hard disc, or a solid state drive (SSD), or in a recording medium, such as an integrated circuit (IC) card, an SD card, or a digital versatile disc (DVD).

A group of control lines and data lines considered to be necessary for description are illustrated, and all control lines and information lines needed for configurations are not necessarily illustrated. It is safe to assume that, actually, almost the entire constituent elements are interconnected.

### REFERENCE SIGNS LIST

100 postmortem generation system
101 ticket
101A generation-source ticket
101B related ticket
112 task memo
113 task memo summary
114 ticket summary
120 agent
121 instruction information
140 language model
150 postmortem
201 ticket management apparatus
202 generation support apparatus
203 communication terminal
204 external apparatus
210 network
220 function definition information
221 related ticket search condition
222 related ticket search history
301 processor
302 storage device
400 operation program
401 ticket search process
402 ticket updating process
403 task memo acquiring process
404 ticket acquiring process
405 postmortem updating process
461 ticket summary text
500 Chatbot program
501 prompt analysis program
502 task memo summary program
503 ticket summary program
504 postmortem generation program
624 task memo summary text
625 task memo summary vector
641 ticket summary text
642 ticket summary vector
740 check item group
1201 prompt analysis information

1. A generation support system comprising:
a processor that executes a program; and a storage device that stores the program, wherein
when a natural sentence that is text data of a natural language is inputted, the generation support system accesses a language model that interprets the natural sentence and that probabilistically predicts an answer sentence to the natural sentence, and wherein
the processor executes:
a first requesting process of outputting a generation-source ticket of the natural sentence related to an incident, a check item group to be checked for the incident, and a first prompt that is the natural sentence requesting that an answer sentence about each check item of the check item group be generated with reference to the generation-source ticket, to the language model;
a first acquiring process of causing the language model to acquire a postmortem including a result of a first trial of generation of an answer sentence about the each check item in the first prompt, as a result of output of the generation-source ticket, the check item group, and the first prompt by the first requesting process; and
a first output process of outputting the postmortem acquired by the first acquiring process.

2. The generation support system according to claim 1, wherein
the processor
executes a first determining process of determining whether an insufficient item is present in a first postmortem acquired by the first acquiring process, the insufficient item being a check item among the check item group that gives the result of the first trial that is not an answer sentence allowing check of the check item, and wherein
in the first output process, the processor outputs the first postmortem for which whether the insufficient item is present therein is determined by the first determining process.

3. The generation support system according to claim 2, wherein
the processor executes:
a search process of retrieving a related ticket related to the generation-source ticket, from a ticket group, based on a search query about the insufficient item;
a second requesting process of outputting the related ticket retrieved by the search process and a second prompt requesting generation of the answer sentence about the insufficient item using the related ticket, to the language model;
a second acquiring process of causing the language model to acquire a result of a second trial of generation of an answer sentence about the insufficient item in the second prompt, as a result of output of the related ticket and the second prompt by the second requesting process; and
a second output process of outputting the result of the second trial acquired by the second acquiring process.

4. The generation support system according to claim 3, wherein
each ticket of the ticket group includes a ticket summary vector that is an embedded expression made by vectorizing a ticket summary text summarizing the ticket, and wherein
in the search process, the processor retrieves a ticket that corresponds to a search query about the insufficient item and that has a ticket summary vector whose distance to a ticket summary vector of the generation-source ticket is equal to or less than a given distance, from the ticket group, as the related ticket.

5. The generation support system according to claim 3, wherein
in the second acquiring process, the processor acquires a second postmortem including the check item group, the result of the first trial, and the result of the second trial, and wherein
in the second output process, the processor outputs the second postmortem acquired by the second acquiring process.

6. The generation support system according to claim 3, wherein
the processor
executes a second determining process of determining whether the insufficient item is present, based on the result of the second trial acquired by the second acquiring process.

7. The generation support system according to claim 6, wherein
the processor
repeatedly executes the search process, the second requesting process, the second acquiring process, and the second output process until determining by the second determining process that the insufficient item is no longer present.

8. The generation support system according to claim 1, wherein
the generation-source ticket includes a task memo summary text summarizing a task memo describing task content on the incident.

9. A generation support method executed by a generation support system comprising a processor that executes a program, and a storage device that stores the program, wherein
when a natural sentence that is text data of a natural language is inputted, the method allows the generation support system to access a language model that interprets the natural sentence and that probabilistically predicts an answer sentence to the natural sentence, and wherein
the method causes the processor to execute:
a first requesting process of outputting a generation-source ticket of the natural sentence related to an incident, a check item group to be checked for the incident, and a first prompt that is the natural sentence requesting that an answer sentence about each check item of the check item group be generated with reference to the generation-source ticket, to the language model;
a first acquiring process of causing the language model to acquire a postmortem including a result of a first trial of generation of an answer sentence about the each check item in the first prompt, as a result of output of the generation-source ticket, the check item group, and the first prompt by the first requesting process; and
a first output process of outputting the postmortem acquired by the first acquiring process.

10. A generation support program causing a processor that, when a natural sentence that is text data of a natural language is inputted, can access a language model that interprets the natural sentence and that probabilistically predicts an answer sentence to the natural sentence, to execute:
a first requesting process of outputting a generation-source ticket of the natural sentence related to an incident, a check item group to be checked for the incident, and a first prompt that is the natural sentence requesting that an answer sentence about each check item of the check item group be generated with reference to the generation-source ticket, to the language model;
a first acquiring process of causing the language model to acquire a postmortem including a result of a first trial of generation of an answer sentence about the each check item in the first prompt, as a result of output of the generation-source ticket, the check item group, and the first prompt by the first requesting process; and
a first output process of outputting the postmortem acquired by the first acquiring process.
